(19) United States
(12) Patent Application Publication
(10) Pub. No.: US 2002/0056455 A1
(43) Pub. Date: May 16, 2002

(54) Self-contained diving unit with integrated human-operated pump

(75) Inventors: Serge Vigny, Thorens-Gliercs (FR); Benoit Saillet, Albens (FR)

Correspondence Address: GREENBLUM & BERNSTEIN, P.L.C., 1941 ROLAND CLARKE PLACE, RESTON, VA, 20191, US

(73) Assignee: SALOMON S.A, Metz-Tessy (FR)

(21) Appl. No.: 09/986,508

(22) Filed: Nov. 9, 2001

(30) Foreign Application Priority Data
Nov. 13, 2000 (FR) 0014751
Dec. 21, 2000 (FR) 0017125

(51) Int. Cl. A62B 7/00; A62B 9/00

(52) U.S. Cl. 128/205.22

(57) ABSTRACT

A self-contained diving unit to be refilled by a manual pump making possible to compress gas in a tank. The pump is integrated into the diving unit. The diving unit can also include an outer case that encloses the tank in particular In addition, the pump is positioned within the outer case of the diving unit and outside the tank.

### CROSS-REFERENCE TO RELATED APPLICATIONS

This application is based upon French Patent Application No. 00 14751, filed Nov. 13, 2000, and French Patent Application No. 00 17125, filed Dec. 21, 2000, the disclosures of which are hereby incorporated by reference thereto in their entireties, and the priorities of which are hereby claimed under 35 U.S.C. §119.

### BACKGROUND OF THE INVENTION

1. Field of the Invention

The present invention relates to a human refilled self-contained diving unit adapted in particular, but in a non-limiting fashion, to short range diving.

2. Description of Background and Relevant Information

In the prior art, there are devices that are filled by the user. U.S. Pat. No. 2,906,263 describes an air tank adapted to be carried on the user's back, to which a manual pump is externally attached. In addition, the manual pump can pivot with respect to the tank to enable replenishment when the tank is positioned on the user's back. However, during the diving phase, the pump runs the risk of getting caught, particularly in sea-weed, thus compromising the diver's safety. Similarly, during transportation out of water, the pump, which projects with respect to the tank, runs the risk of getting caught and/or of being subject to impacts that could damage the connection between the pump and the tank. During the diving phase, such damage could induce a leak from the tank and therefore seriously compromise the diver's safety.

### SUMMARY OF THE INVENTION

Therefore, one of the objects of the invention is to remedy the aforementioned drawbacks while limiting the problems related to imperviousness.

To achieve these objects, the self-contained diving unit includes a human-operated pump integrated therein. This pump is positioned within the outer case of the diving unit which also incorporates a tank. In addition, the human-operated pump is positioned outside the tank, which makes it possible to reduce the problems related to imperviousness at the connection between the pump and the tank.

In a first embodiment, the pump is manufactured separately from the diving unit, and then positioned in the diving unit.

In a second embodiment, the pump uses components of the diving unit to operate.

In a third embodiment, the pump is partially integrated into the diving unit.

In certain embodiments, the pump is a manual pump, which the user actuates with his/her arms. In other embodiments, the pump is a foot-actuated pump.

### BRIEF DESCRIPTION OF DRAWINGS

The invention will be better understood, and other advantages thereof will become apparent from the description that follows, with reference to the annexed drawings. The description illustrates, by way of non-limiting examples, certain preferred embodiments.

FIG. 1 schematically shows a front view of the diving unit.

FIG. 2 schematically shows a transverse cross-section of the diving unit according to the first embodiment.

FIG. 3 schematically shows a transverse cross-section of the diving unit according to an alternative of the first embodiment.

FIG. 4 schematically shows a transverse cross-section of the diving unit according to the second embodiment.

FIG. 5 schematically shows a perspective side view of the diving unit according to the third embodiment.

FIG. 6 schematically shows a front view of the front of a diving unit according to a fourth embodiment, equipped with a foot-operated pump having two pistons.

FIG. 6A schematically shows a side view of the diving unit illustrated in FIG. 6, with areas of the pump and at the top of the unit broken-away for convenience in understanding.

FIG. 7 schematically shows a front view of the rear of a diving unit according to a variation of the fourth embodiment, equipped with a foot-operated pump having two pistons.

FIG. 7A schematically shows a side view of the diving unit illustrated in FIG. 7, with the area of the pump broken-away for convenience in understanding.

FIG. 8 schematically shows a front view of the front of a diving unit equipped with a foot-operated pump having one piston.

FIG. 8A schematically shows a side view of the diving unit illustrated in FIG. 8, with the area of the pump broken-away for convenience in understanding.

FIG. 9 schematically shows a side view of a detail of the pump illustrated in FIGS. 6-7A.

FIG. 10 shows a block diagram of the diving unit according to the fourth embodiment and according to a method of serial connection of the pistons.

FIG. 11 shows a block diagram of the diving unit according to the fourth embodiment and according to a method of parallel connection of the pistons.

FIG. 12 schematically shows a perspective front view of the second embodiment.

### DETAILED DESCRIPTION OF THE INVENTION

The self-contained diving unit 1 is defined as a breathing assembly enabling a diver to breath independently under water, without requiring any connection with the surface.

The self-contained diving unit 1 includes at least one tank 2 adapted to contain a gas under pressure, and possibly a carrying device. The tank 2 has an inlet opening 203 and an outlet opening 206 to which a breathing nozzle 202 enabling the user to breathe the gas contained in the tank 2 is connected. A gas pressure reducing valve can advantageously be positioned between the tank 2 and the breathing nozzle 202. The gas pressure reducing valve makes it possible to lower the pressure of the gas contained in the tank 2 so that it becomes breathable by the diver.

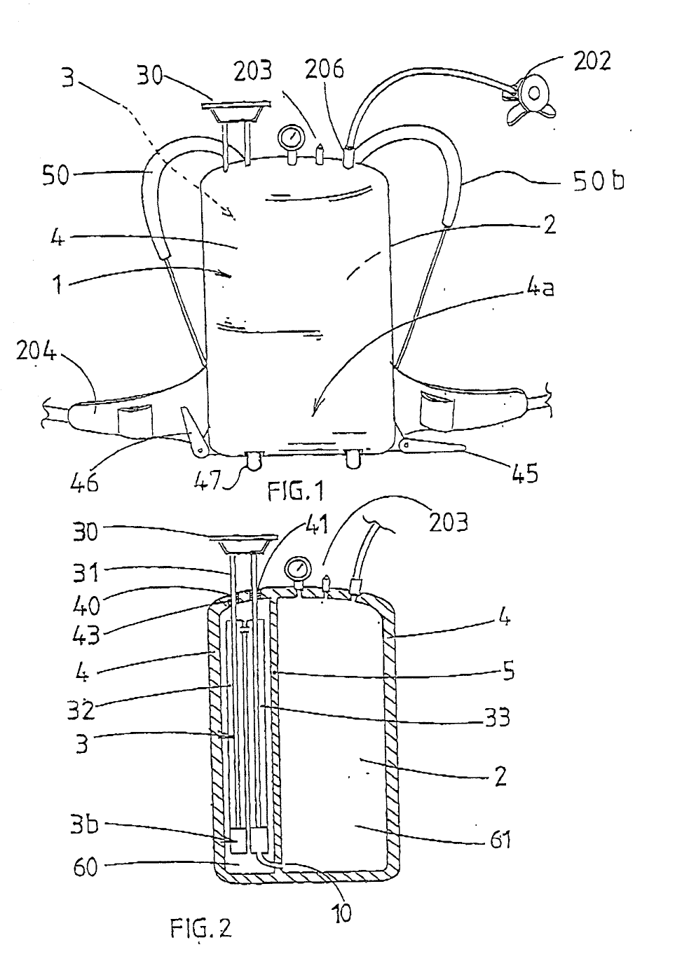

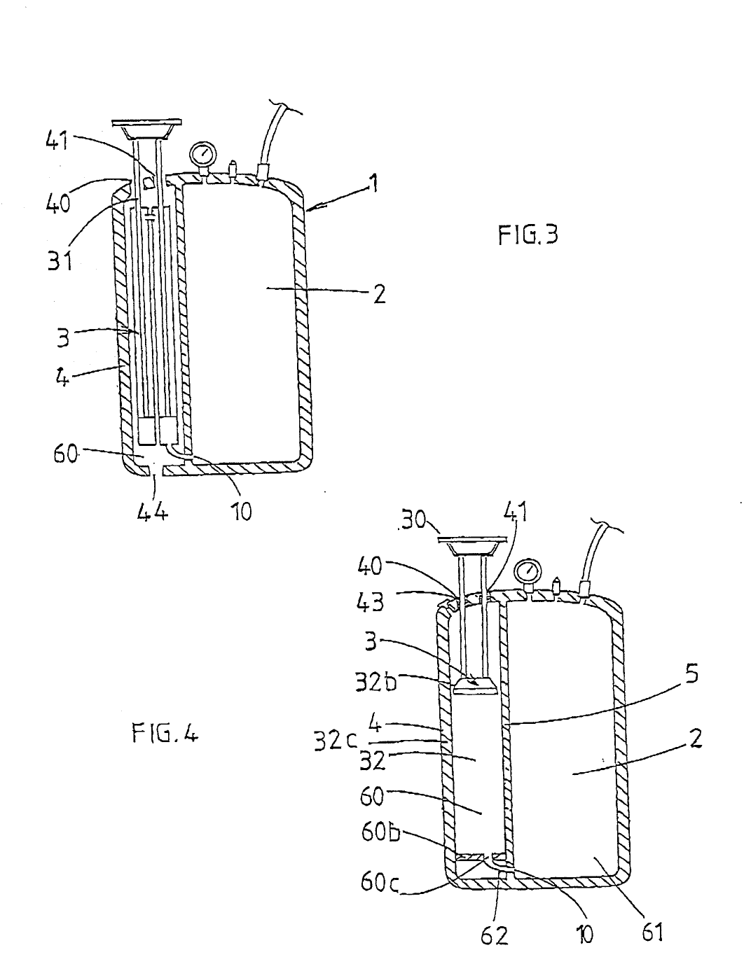

In FIG. 1, the carrying device is represented by at least one shoulder trap 50, 50b and a belt 204 which make it possible to affix the diving unit 1 on the diver's back at least during diving. It is contemplated that the carrying device may include a belt only for carrying the diving unit on the hips.

Moreover, the diving block 1 can advantageously include at least one wheel 47, two being shown in FIG. 1, attached to the outer case 4 so as to constitute a transportation mechanism making it easier to carry the diving unit when out of the water. Thus, the user can pull or push the diving unit 1 by rolling it on the ground. This transportation mechanism can complete or replace the carrying device.

The diving unit 1 includes a manual pump 3 that makes it possible to compress the gas in the tank 2. This pump 3 is operated by the user who performs the work necessary to the functioning of the pump 3 by actuating the gripping handle 30 with at least one of his/her hands. To facilitate the actuation of the pump 3 and to reduce the physical fatigue due to the pumping, the diving unit 1 advantageously includes at least one footrest 45, 46 positioned in the lower portion 4a of the diving unit 1.

In the preferred embodiment shown in FIG. 1, the diving unit 1 includes an outer case 4 that encloses the tank 2. This outer case 4 defines an outer physical boundary of the diving unit 1, and makes it possible to limit the risks of the diving unit 1 of getting caught during the diving phase. This outer case 4 therefore advantageously has a smooth or streamlined ergonomic shape.

The footrests 45, 46 are positioned outside the outer case 4, in its lower portion 4a, and preferably arranged symmetrically. To actuate the gripping handle 30 of the manual pump 3, the user positions his/her feet on the footrests 45, 46 and, with his/her own weight, thus stabilizes the diving unit 1 during the pumping phase

In addition, the manual pump 3 is integrated into the diving unit 1, which makes it possible in particular to undertake a series of dives without having to come back to the starting point, and without the need to have access to a compressor. This integration into the diving unit 1 also makes it possible to limit the risks that the pump may get caught during diving and also during transportation of the diving unit 1.

According to the invention, the pump 3 is positioned within the outer case 4 of the diving unit 1. However, the gripping handle 30 of the manual pump 3 is positioned such that it can be accessed from outside the outer case 4, in order to actuate the manual pump 3. In addition, the manual pump 3 is positioned outside the tank 2, which reduces the problems of imperviousness by limiting the number of joints and the length of these joints, both at the pump 3 and at the tank 2.

To obtain this result, the diving unit 1, shown in cross-section in FIG. 2, includes at least one partition 5 which demarcates at least two compartments 60, 61 in the outer case 4. Thus, the pump 3 is positioned in one of the compartments 60 and the tank 2 is positioned in the other compartment 61. Moreover, the partition 5 includes at least one opening 10 that makes it possible to connect the pump 3 to the tank 2.

In the embodiment shown in FIG. 2, the outer case 4 constitutes at least one portion of the wall of the tank 2. Similarly, the partition 5 constitutes at least one portion of the wall of the tank 2. Thus, the compartment 61 directly constitutes the tank 2 in which the gas under pressure is stored. Therefore, the outer case 4 must be dimensioned accordingly to resist the intrinsic pressure of the gas under pressure which is applied within these walls.

The compartment 61 can also be equipped with an internal conditioning adapted to receive the gas under pressure, such as an aluminum can or a flexible envelope. Thus, the stresses generated by the gas under pressure are recovered by this internal conditioning, which makes it possible to obtain a lighter structure in the area of the outer case 4.

However, in this embodiment, the pump 3 functions independently of the diving unit 1 while being integrated therein. The pump body 3b is arranged in the compartment 60 of the diving unit 1. This means that the manual pump 3, in particular with respect to the pump body 3b, can be manufactured separately from the diving unit 1. Respecting this constructional arrangement advantageously makes it possible to have at least the pump body 3b manufactured by a specialized contractor, and to only perform the integration of the pump 3 into the diving unit 1. Indeed, in order for the physical energy spent by the user to carry out the pumping to be minimized as much as possible, more efficient pumps are desired, especially with respect to the piston or pistons 32, 33 which are positioned in the pump body 3b.

Since the pump body 3b is positioned in the outer case 4, and the gripping handle 30 is positioned outside the outer case 4, the outer case 4 includes at least one opening 40, 41 through which a shaft 31 connecting the handle 30 to the pump body 3b passes.

In the embodiment shown in FIG. 2, the compartment 60, which contains the pump body 3b, is impervious. To this end, the openings 40, 41 are provided with a sealing joint 43 that enables the axial displacement of the shaft 31 while ensuring the imperviousness of the opening. In addition, the air intake for supplying the pump 3 can advantageously be done by the shaft 31, in the area of the handle 30. Respecting this constructional arrangement makes it possible to avoid the problems related to the imperviousness of the pump body 3b during the diving phase, in view of the external pressure exerted by water during diving. Indeed, since the compartment 60 is impervious, it substantially maintains the air pressure; the difference in pressure between the inside and the outside of the compartment 60 can be relatively substantial. However, an outer case 4 capable of withstanding this difference in pressure must be obtained. A construction of the same type can be envisioned with a rotating manual pump 3. The manual pump 3 is positioned in the compartment 60, but the shaft 31, which connects the pump 3 to a rotatable actuating system for the hands, is rotated. The opening 40 of the outer case 4, through which the shaft 31 passes, is then provided with a sealing joint 43 that enables the rotational movement of the shaft 31 while ensuring the imperviousness of the opening.

Tests have shown that the outer case could advantageously be made of a fiber-impregnated thermoplastic material, such as glass fiber-impregnated polyamide, having a thickness between about 1 and 3 millimeters. The outer case thus obtained resists internal pressures of about 20 bars without any problem for the compartment 61 and external excess pressures, in the area of the compartment 60, which correspond to dives at a depth of about 10 meters. Moreover, the use of injected material makes it possible to obtain streamlined geometries of the outer case 4 in order to reduce the risks of getting caught during the dive. Other materials, such as aluminum alloy, can be used by way of non-limiting examples,

FIG, 3 shows an alternative of the first embodiment in which the compartment 60 is not impervious. Thus, the openings 40, 41, in which the shaft 31 of the manual pump 3 passes are not impervious. However, so that water does not remain in the compartment 60, the outer case 4 advantageously includes a lower opening 44 in the area of the compartment 60.

This alternative makes it possible to simplify the assembly of the manual pump 3 in the diving unit 1; however, it requires the use of a more technical pump 3. Indeed, during the diving phase, the pump 3 is in contact with water, such as sea water which is very corrosive. In addition, the opening 10 for connecting the pump 3 and the tank 2, which is equipped with a sealing joint, is also subject to this corrosive attack.

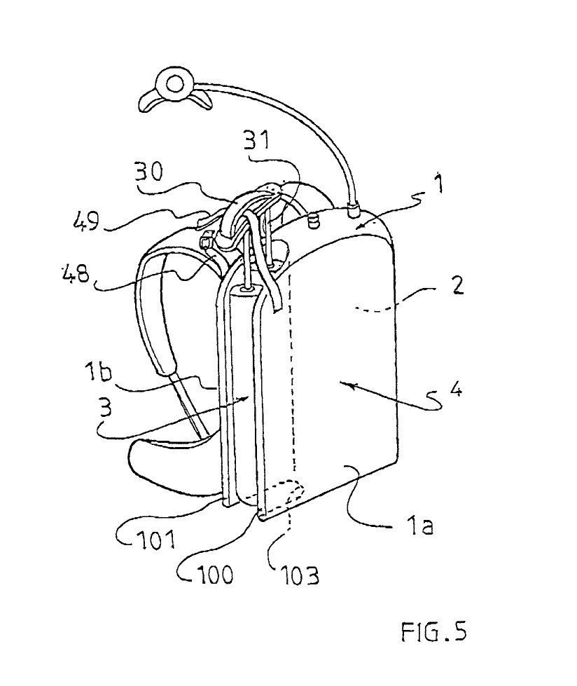

In FIG. 4, the diving unit 1 is shown according to the configuration of the second embodiment, according to which the manual pump 3 uses the walls of the diving unit 1 to ensure its functioning. As in the previous embodiment, the diving unit 1 includes the outer case 4 as well as the partition 5 which demarcates the compartment 61 serving directly as a reservoir 2. However, the compartment 60 and the manual pump 3 differ from the previous embodiment.

The manual pump 3 includes at least one piston 32 that has a cylinder 32c in which the piston head 32b slides. The partition 5 constitutes at least a portion of the wall of the cylinder 32c of the piston 32 of the pump 3. In addition, the outer case 4 also constitutes a portion of the wall of the cylinder 32c of the piston 32. In fact, the compartment 60 directly constitutes the cylinder 32c of the piston 32. The piston head 32b, which is actuated by the handle 30, therefore has a shape complementary to the compartment 60 so as to ensure the imperviousness and functioning of the piston 32. Furthermore, the imperviousness of the top portion of the piston 32 is ensured by sealing joints 43 positioned in the openings 40, 41 through which the shaft 31 for actuating the manual pump 3 passes.

In this embodiment, the piston 32 is demarcated at its base by a substantially horizontal wall 60b positioned substantially above the opening 10 feeding the tank 2. The wall 60b includes an opening 60c from which extends a pipe 62 connected to the opening 10. This arrangement makes it possible to optimize the functioning of the pump 3. The compartment 60 can be divided into at least two pistons, due to at least one additional partition. These pistons remain partially demarcated by the outer case 4. To meet the need of complementarity between the piston head 32b and the compartment 60, in particular with respect to a pump 3 having two pistons, the outer case 4 can advantageously be made of thermoformed materials as described previously.

In FIG. 5, the diving unit 1 is shown according to the third embodiment according to which the outer case 4 constitutes a partial protection of the manual pump 3. The diving unit 1 still includes the tank 2 which is enclosed in the outer case 4. The diving unit 1 also includes the manual pump 3 which is arranged outside the outer case 4. The outer case 4 extends laterally, along at least one excrescence, or projection, 100, 101. The pump 3 is fixed to the outer case 4 so as to be covered, at least partially, by the excrescences 100, 101.

In the embodiment shown in FIG. 5, the outer case 4 includes two excrescences 100, 101 that extend laterally along a plane parallel, or substantially parallel, to the rear surface 1b of the diving unit, which excrescences are adapted to be in contact with the user's back. The excrescences 100, 101, which are advantageously arranged along the extension of the front surface la and of the rear surface 1b, respectively, form a housing 103 adapted to receive the manual pump 3. These excrescences 100 and 101 make it possible to incorporate the manual pump 3 into the diving unit 1, although the pump 3 is positioned outside the outer case 4. Indeed, by covering the pump 3 at least partially, the excrescences 100, 101 limit the risks of the pump of getting caught during the diving phase.

To perfect this function, the gripping handle 30, when retracted, is advantageously integrated into the diving unit 1. When the shaft 31 is completely engaged into the piston 32, 33, the handle 30, thus retracted, remains within the overall shape defined by the outer case 4 and is in continuity with the latter. Moreover, the gripping handle 30 advantageously includes a closure device 48 complementary to the diving unit 1, which makes it possible to maintain the handle 30 in the retracted position. This closure device is illustrated by a strap 48 fixed at each of its ends on one of the surfaces 1a, 1b, respectively, of the outer case 4, and which passes in the handle 30. The strap 48 has an adjusting mechanism 49 which makes it possible to maintain the handle 30, in the retracted position, against the outer case 4. Thus, during the diving phase, the handle 30 is positioned and maintained in the closed position, therefore making it possible to limit the risks of the diving unit 1 of getting caught in elements external to the unit.

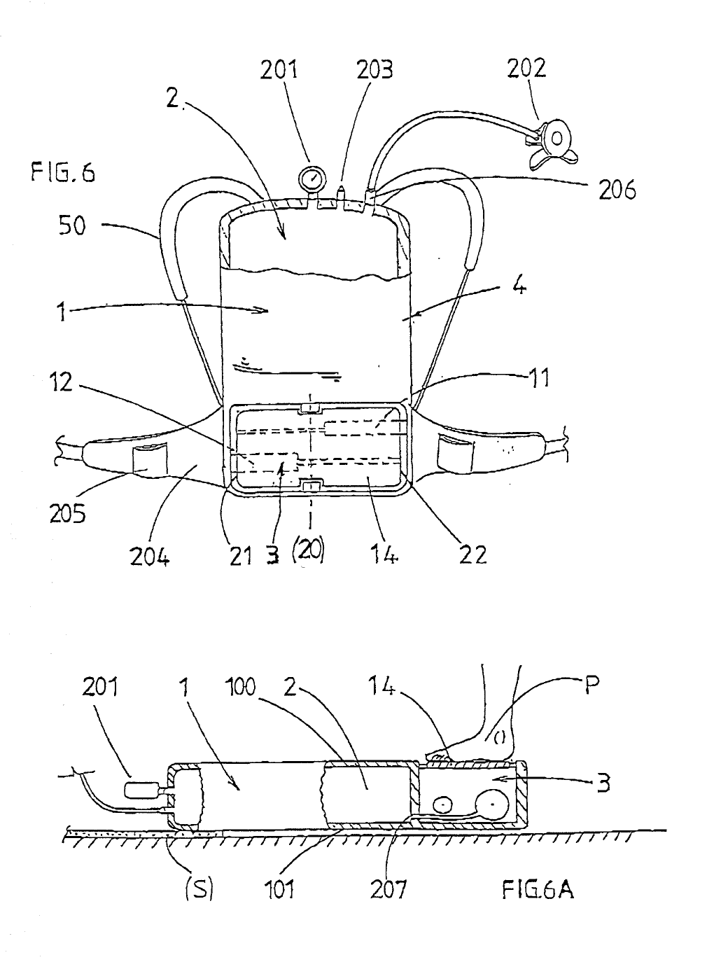

In the fourth embodiment of the invention shown in FIGS. 6 and 6A, the pump 3 is a foot pump which, according to the invention, is fixed to the diving unit 1 and integrated therein, i.e., integrated into the space of the outer case 4 which also contains the tank 2, but it is arranged outside the latter.

The air tank 2 can advantageously be equipped with a pressure measuring device 201 that measures the pressure of the gas in the tank 2, and which indicates indirectly the amount of self-sufficient breathing capability remaining in the tank 2.

The pump 3 is connected to the tank 2 only via at least one inlet opening 207 This inlet opening 207 makes it possible to fill and pressurize the gas within the tank 2 by the action of the pump 3. With respect to the inlet opening 203, which is also connected to the tank 2, it is adapted to be connected to a compressor to possibly ensure an occasional filling of the tank 2.

The pump 3 includes a pedal 14 that makes it possible to transmit the motive force exerted by the user's feet P to the pump 3. This pedal 14 is pivotally mounted about an axle 20 which, in this constructional configuration, is oriented along, or substantially along, the longitudinal axis of the diving unit 1 The pedal 14 is connected, at least at ones of its ends 21, 22, to a piston 11, 12. Since the pump 3 has two pistons 11, 12, the end 21 is connected to the piston 11 and the end 22 is connected to the piston 12 according to an operating mode which will be detailed subsequently.

Moreover, the pedal 14 of the pump 3 is positioned substantially on the front surface 100 of the diving unit 1, which is opposite the rear surface 101 on which the shoulder straps 50 are attached. Thus, to actuate the pump 3, the user lays the diving unit against a support S, such as the ground, with the rear surface 101 in support against this support S. Then, the user steps on the diving unit 1, on the pedal 14. Thus, the diving unit I is inserted between the foot P of the user and the support S. Given that the power needed by the pump 3 to function is provided by the user's legs, this power also uses the user's weight. This constructional arrangement makes it possible to fill and compress the air in the tank 2 at the pressure necessary for diving without much exertion and without physically exhausting the user.

In the embodiment described in FIGS. 6 and 6A, the pump 3 is positioned within the perimeter defined by the outer case 4, beneath the tank 2 and substantially in the area of the belt 204. This arrangement makes it possible in particular to concentrate the load at the level of the belt, which makes it easier to carry the diving unit 1 out of the water. In addition, the belt 204 advantageously includes at least one pocket 205 adapted to hold a ballast, such as stones. The ballast can also be positioned directly in the diving unit 1, in particular in the area of a closed compartment that would be arranged in the outer case 4 of the diving unit 1.

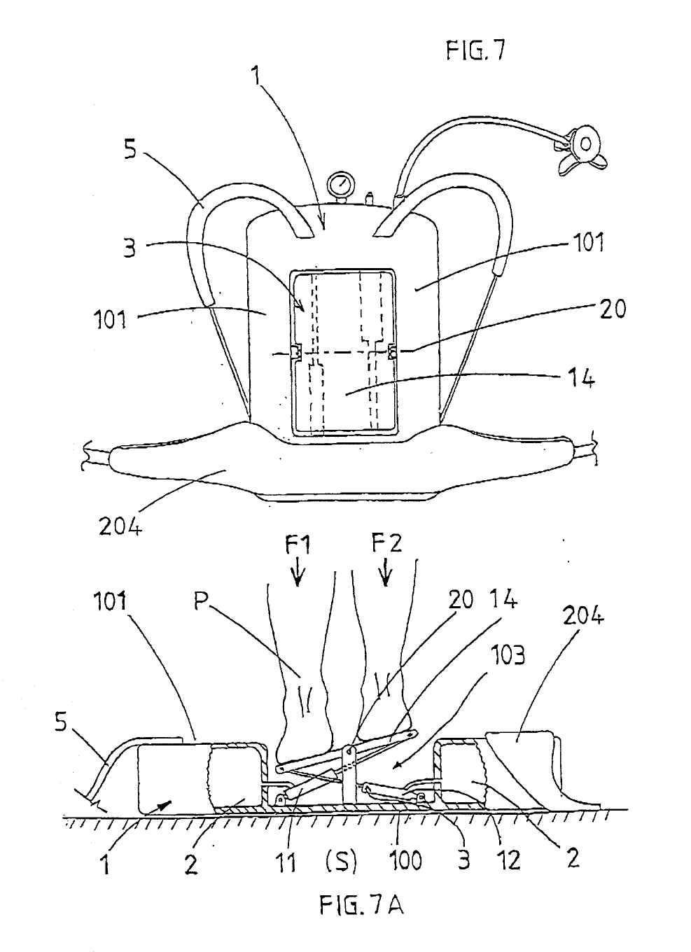

FIGS. 7 and 7A show a variation of embodiment according to which the pedal 14 is positioned on the rear surface 101 on which the shoulder straps 50 are also positioned.

As the belt 204 can advantageously cover the lower portion of the rear surface 101 of the diving unit 1, for improved comfort during transportation, the pump 3 is positioned substantially in the center of the rear surface 101, in a housing 103 that is closed by the pedal 14. Thus, the pump 3 is surrounded by the tank 2 as shown in FIG. 7A.

In order not to hit the user's back when the diving unit 1 is being carried, the axle 20 of the pump 3 is advantageously positioned between the front surface 100 and the rear surface 101 Thus, when the unit is carried, the pedal 14 is held by an appropriate device in a stable position substantially parallel to the rear surface 101. Respecting this constructional arrangement makes it possible to maintain the pedal 14 stabilized and set back from the user's back.

To fill the tank 2, the user positions the diving unit 1, with its front surface 100 in support against the support S. Then the user steps on the diving unit 1, at the level of the pedal 14, on the rear surface 101.

To actuate the pump 3, the user alternatively and repeatedly exerts a force F1 on his left leg and a force F2 on his/her right leg. This succession of actions makes it possible to pivot the pedal 14 about the axle 20 in an oscillating tilting movement. This pedal 4 alternatively drives the pistons 11, 12 of the pump 3.

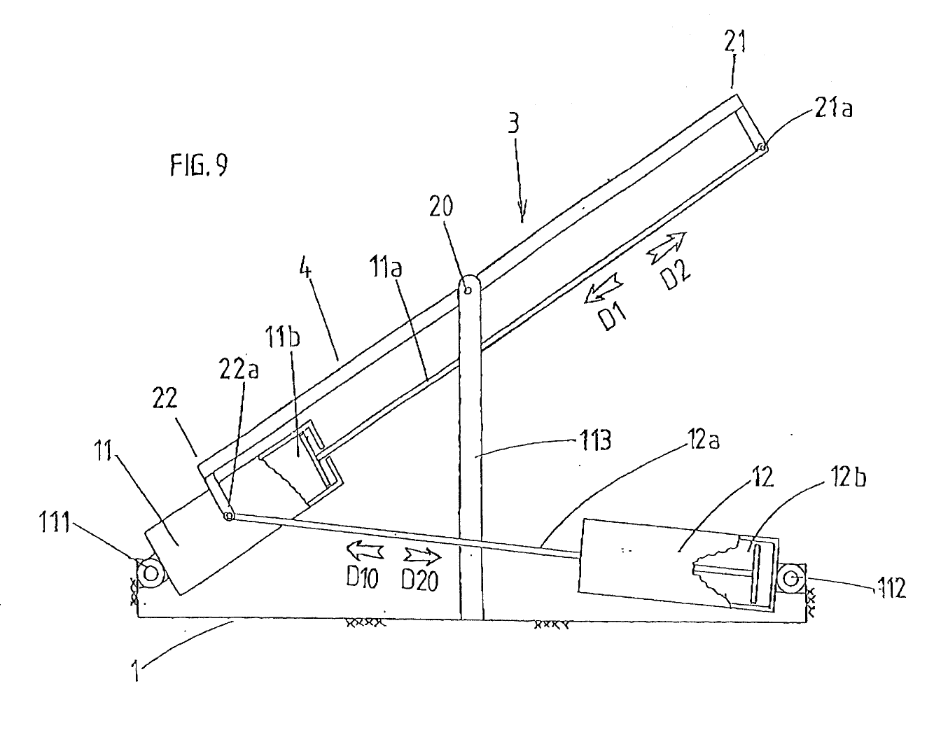

61 FIG. 9 shows a detail of the pump 3 used in the embodiment illustrated in FIGS. 6-7A.

The pump 3 includes two pistons 11, 12 that are positioned in different planes. The pistons 11, 12, which work axially, are pivotally mounted about an axle 111, 112, respectively, which are themselves fixed on the outer case of the diving unit 1. In addition, the pedal 4 is pivotally mounted about the axle 20 that is mounted in an arm 113, which is in turn fixed on the diving unit 1. The axles 111, 112 as well as the arm 113 can be fixed on the tank 2.

To respect kinematics of the pivotal operation of the pedal 14, an end 22 of the pedal 14 is connected to the piston 12 via an axle 22a. Similarly, the other end 21 of the pedal 4 is connected to the piston 11 via an axle 21a. The ends 21, 22 are connected to the arms 11a, 12a, respectively, which slide axially in the chambers 11b, 12b of the pistons 11, 12 and which compress the gas.

In addition, the axles 111, 112, and 22a, 21a and 20 are oriented substantially in the same direction to respect to the kinematics of the pump 3 The kinematics of the pump 3 generate simultaneous movements of the arms 11a, 12a with respect to their respective piston 11, 12. When the arm 11a; engages into the piston 11, namely a displacement D1, the arm 12a comes out of the piston 12, namely a displacement D10. Thus, the displacement D1 is simultaneous to D10, and inversely, the displacement D2 is simultaneous to the displacement D20.

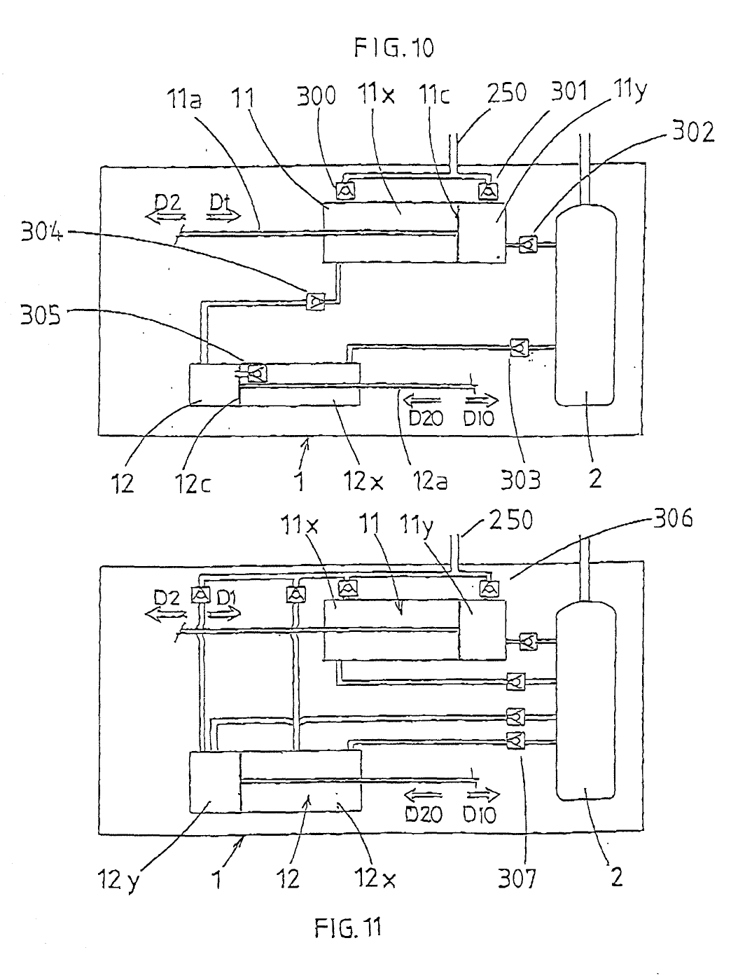

FIG. 10 shows a block diagram of the diving unit 1, when the two pistons 11, 12 are arranged serially. An air intake 250 makes it possible to supply the piston 11 with air coming from outside the diving unit 1, via two anti-return valves 300, 301 which supply the upper chamber 11x and the lower chamber 11y, respectively, of the piston 11. The volume of the chambers 11y and 11x varies as a function of the position of the head 11c in the piston 11.

The pedal for actuating the pump causes either simultaneous displacements D2 and D20, or simultaneous displacements D1 and D10 on the two arms 11a and 12a, respectively.

The movement D1 causes air to fill the chamber 11x and pressurize the air contained in the chamber 11y, which is blown directly into the tank 2 by an anti-return valve 302.

The movement D1 is accompanied by the movement D10 which compresses and blows the air contained in chamber 12x of the piston directly into the tank 2 via an anti-return valve 303.

The movement D2 compresses and blows the air contained in the chamber 11x of the piston 11 toward the piston 12 via an anti-return valve 304. Indeed, the two pistons 11, 12 are arranged serially and are connected to one another by an anti-return valve 304.

The movement D2 is accompanied by the movement D20 which, via the valve 305, transfers the air from the chamber 12y toward the chamber 12x.

Furthermore, to benefit from the serial positioning of the pistons, the piston 12 is substantially half the volume of the piston 11.

Indeed, the anti-return valve 305 is arranged on the head 12c of the piston 12. Respecting this constructional arrangement makes it possible to obtain a pump that increases the compression power in each of the pistons 11 and 12, and thus to diminish the effort to be produced by the user to fill and compress the air in the tank 2.

FIG. 11 shows an alternative of the pump 3 in which the two pistons 11, 12 are parallel. Each chamber 11x, 11y and 12x, 12y pertaining to the pistons 11 and 12, respectively, is supplied with air directly by the external air intake 250 via an anti-return valve 306 for each piston chamber 11y, respectively. The simultaneous movements D2, D20, or D1, D10 compress the air in one of the chambers of each piston 11, 12, which is evacuated via an anti-return valve on the tank 2, Indeed, the two pistons 11, 12 supply the tank 2 only and directly, and each of the chambers 11x, 11y, 12x, 12y of each piston 11, 12 is connected to the tank 2 by an anti-return valve 307.

Because this embodiment uses a direct compression of the air, it remains relatively efficient, because the pistons 11, 12 compress the gas during both the compression phase (D1, D20) and the expansion phase (D2, D10) of the pistons 11, 12. This makes it possible to reduce the physical labor which the user must produce to carry out the pumping.

In the embodiment shown in FIGS, 8 and 8a, the pump 3 has only one piston 11 which is actuated by the pedal 14 cooperating with the user's foot P. The piston 11 directly supplies the tank 2 with compressed gas via an opening 251.

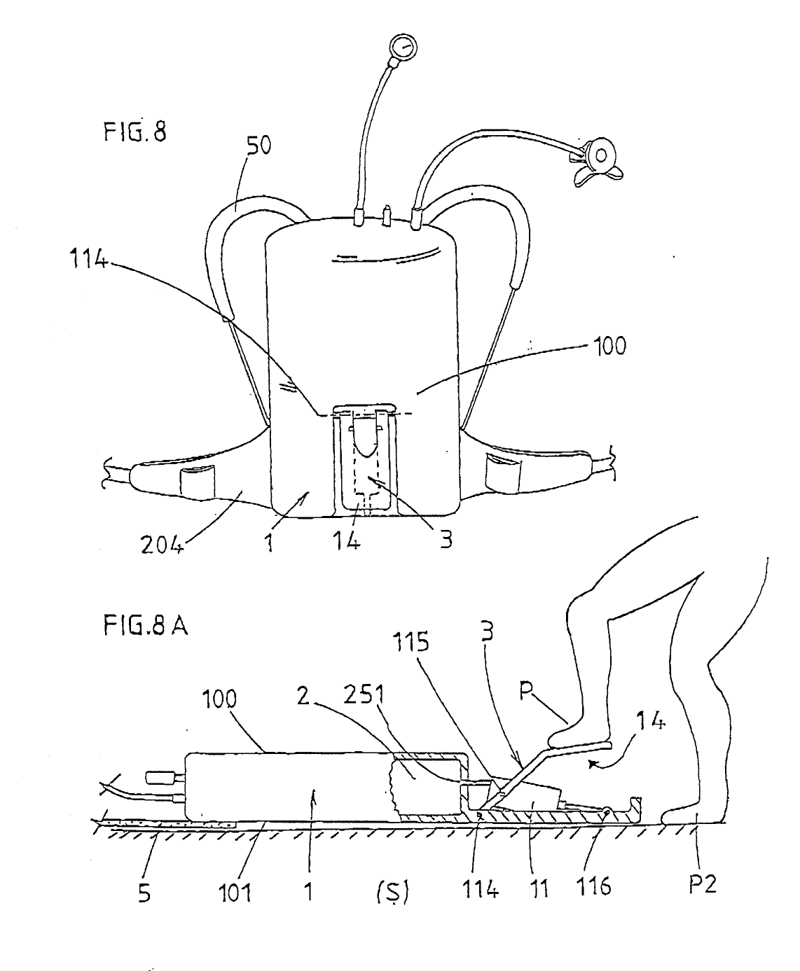

The pump 3 illustrated in FIG. 8A has a conventional and known construction according to which the pedal 14 is pivotally mounted with respect to the diving unit 1 about an axle 114, whereas the piston 11 is pivotally mounted on one side with respect to the diving unit 1 about the axle 116 and on the other side with respect to the pedal 14 about the axle 115.

In the preferred embodiment shown in FIG. 8, the pump 3 is positioned substantially at the periphery of the diving unit 1 and outside the tank 2, such that the journal axle 114 of the pedal 14 is arranged substantially away from the periphery of the diving unit 1. Respecting this constructional arrangement makes it easier to actuate the pump 3 with the user's foot P since, as shown in FIG. 8A, the user can place a foot P on the pedal 14 and the other foot P2 on the support (S) on which the diving unit 1 is supported.

Additionally, the feet P and P2 are slightly spaced apart along the front-to-rear direction of the user, which makes it easier for the user to maintain his balance when pumping, and thus indirectly reduces the fatigue induced by the pumping.

In the embodiment shown in FIGS. 8 and 8A, the diving unit 1 includes the shoulder straps 50, which are positioned and fixed on the rear surface 101 and are adapted to come into contact with the user's back. Moreover, the pedal 14 of the pump 3 is positioned on the front surface 100 of the diving unit 1, which is opposite the rear surface 101 in a housing demarcated within the perimeter defined by the outer case 4. This housing is open outwardly, but it is closed by the pedal 14 which is in the continuity of the front surface 100. This construction makes it possible to locate the pump 3 in the area of the belt 204, since the belt 204 is also arranged on the rear surface 101.

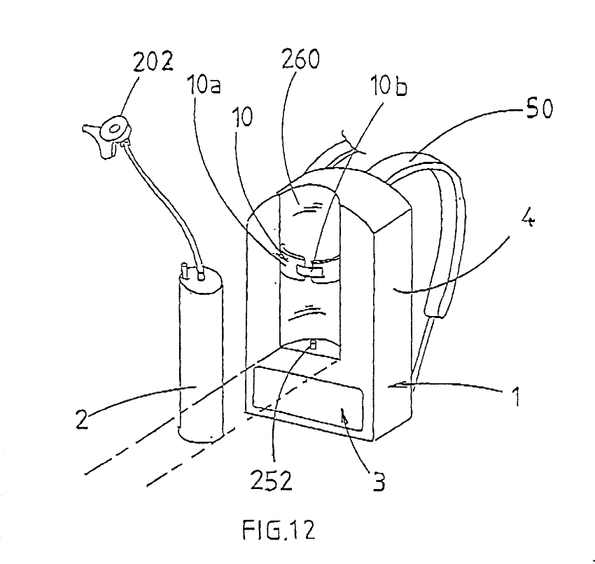

FIG. 12 shows another embodiment according to which the tank 2 is detachable from the diving unit 1. On the one hand, the diving unit 1 includes the pump 3 which is fixed and integrated into the outer case 4 of the diving unit 1, as well as a carrying means such as shoulder straps 50. On the other hand, the tank 2, to which the breathing nozzle 202 in particular is connected, is designed to be separated from the diving unit 1. The tank 2 is complementary to a valve 252 fixed on the diving unit 1. This valve 252 makes it possible to transfer the compressed gas from the pump 3 toward the tank 2 when the latter is positioned on the diving unit 1. To facilitate this positioning, the diving unit 1 advantageously includes a housing 260 substantially complement to the outer shape of the tank 2, this housing being open outwardly but not overlapping the overall perimeter of the outer case 4.

Furthermore, the diving unit 1 includes a detachable attachment assembly 10 capable of ensuring that the tank 2 is held on the diving unit 1, and that the tank 2 can possibly be separated from the diving unit 1. The detachable attachment assembly 10 can be made in particular by a jacket 10a which is tightly held around the tank 2 by a tightening buckle 10b.

This embodiment makes it possible in particular to separate the tank 2 from the diving unit 1 to bring the tank close to a compressor in order to quickly fill the tank 2.

The invention is not limited to the use of the particular pumps described. It is contemplated to be within the scope of the invention to use any hand-operated pump system, especially with translational or rotational axial operation. Thus, the pump 3 can advantageously be actuated by non-human energy, such as solar energy, electric energy, or even energy released by combustion. This operation mode of the pump 3 remains complementary to the actuation mode using human power, and males it possible to locally fill the tank more quickly. The methods for producing non-human energy are known and can be fixed on the diving unit, such as solar panels in particular, or can be independent of the diving unit, such as a mechanical system for actuating the shaft 31 including an electric motor, in particular. According to this alternative embodiment, the pump 3 can be actuated either by at least one hand or at least one foot of the user, or can be actuated by non-human energy.

Similarly, the diving unit 1 can include an additional pump that is actuated by non-human energy, but which is independent of the human-actuated pump 3.

Furthermore, if the technological advance of human-actuated pumps made it possible to increase the pressure in the tank, the diving unit, even when used in medium and long range diving, would remain consistent with the invention.

The present invention is not limited to the particular embodiments described hereinabove, which are provided for guidance only, but encompasses all similar or equivalent embodiments.

What is claimed is:

1. A self-contained diving unit including:
at least one tank adapted to contain a gas under pressure;
a human-operated pump making it possible to compress the gas in the tank;
an outer case enclosing at least the tank; and
the pump being positioned within the outer case and outside the tank.

2. A diving unit according to claim 1, further comprising at least one partition demarcating at least two compartments in the outer case, the pump being positioned in one of the compartments and the tank is positioned in a second compartment.

3. A diving unit according to claim 2, wherein the outer case and the partition constitute at least one portion of a wall of the tank.

4. A diving unit according to claim 2, wherein the human-operated pump includes at least one piston, and wherein the partition and the outer case constitute at least one portion of a wall for a cylinder of the piston.

5. A diving unit according to claim 2, wherein the pump includes an actuating element located outside the outer case and a pump body, and wherein the outer case includes at least one opening through which a shaft connecting the handle to the pump body passes.

6. A self-contained diving unit comprising:
at least one tank adapted to contain a gas under pressure;
a human-operated pump making it possible to compress the gas in the tank;
an outer case enclosing the tank, and
the outer case extending laterally along at least one excrescence that at least partially covers the human-operated pump.

7. A diving unit according to claim 1, wherein the human-operated pump includes an actuating element, in a retracted position said actuating element being integrated into the diving unit, and wherein a gripping handle includes a closure device complementary to the diving unit, the closure device making it possible to maintain the handle in the retracted position.

8. A diving unit according to claim 1, wherein the human-operated pump is a pump that is actuated by at least one hand of a user.

9. A diving unit according to claim 1, wherein the pump is actuated by at least one leg of the user, and wherein the pump is fixed with respect to the diving unit.

10. A diving unit according to claim 9, wherein the pump includes a pedal that is pivotal about an axle, and wherein the pedal is conned, at least at one of its ends, to a piston.

11. A diving unit according to claim 1, further comprising a detachable attachment assembly capable of ensuring that the tank is held on the diving unit and that the tank can be separated from the diving unit.

12. A diving unit according to claim 1, wherein the pump includes two pistons.

13. A diving unit according to claim 12, wherein the two pistons are arranged serially, and wherein the two pistons are connected to one another by an anti-return valve.

14. A diving unit according to claim 12, wherein the two pistons are arranged in parallel, and wherein the two pistons supply the tank only.

15. A diving unit according to claim 12, wherein at least one piston compresses the gas, both during a compression phase and during an expansion phase.

16. A diving unit according to claim 9, further comprising shoulder straps positioned on a rear surface of the diving unit, and wherein the pump comprises a pedal also positioned on the rear surface.

17. A diving unit according to claim 9, further comprising shoulder straps positioned on a rear surface of the diving unit, and wherein the pump comprises a pedal positioned on a front surface of the diving unit, said front surface being opposite the rear surface.
